(19) United States
(12) Patent Application Publication
(10) Pub. No.: US 2004/0076133 A1
(43) Pub. Date: Apr. 22, 2004

(54) Mobile computing device and method for switching connectivity between a mobile computing device and a communication network

(76) Inventors: Debora B. Rinkevich, Austin, TX (US); William M. Droste, Round rock, TX (US); Shepherd S.B. Shi, Austin, TX (US)

Correspondence Address: WEI TE CHUNG, FOXCONN INTERNATIONAL, INC., 1650 MEMOREX DRIVE, SANTA CLARA, CA, 95050, US

(21) Appl. No.: 10/273,457

(22) Filed: Oct. 17, 2002

(51) Int. Cl. H04Q 7/24; H04L 12/66

(52) U.S. Cl. 370/338; 370/352

(57) ABSTRACT

A mobile computing device (101) includes a data storage (310) and an application (300). The application is used for performing functions of the mobile computing device, and includes a connectivity switching module (303) for receiving demands for connection to or disconnection from a communication network, and for switching connectivity between the mobile computing device and the communication network; a data processing module (305) for processing data in the data storage; a data filter (307) for filtering new or changed data in the data storage; a data synchronizing module (309) for synchronizing data in the data storage with data available on the communication network; and an account setting module (301) for setting various dialup accounts for the mobile computing device to be connected to the communication network. A related method for switching connectivity between a mobile computing device and a communication network is also disclosed.

### BACKGROUND OF THE INVENTION

1. Field of the Invention

The present invention relates to a mobile computing device, and particularly to a mobile computing device which can conveniently switch connectivity to a communication network. This application relates to the copending application filed on the same day having the same inventors and the same assignee with the instant application and titled “SYSTEM AND METHOD FOR SYCRONIZING DATA BETWEEN A MOBILE COMPUTING DEVICE AND REMOTE SERVER”.

2. Background of the Invention

Soon after computers were invented, people began connecting them together. Connections among multiple computers enabled scarce resources such as printers and memory devices to be shared. At first, connections between computers were established with wires. As technology advanced and needs for more flexibility developed, wireless communication methods were created and deployed. Early wireless communication techniques involved periodically connecting a mobile device to a network access point via a cable or via infrared signals between the mobile computer and the network access point. These techniques require either attaching wires to the mobile device or placing an infrared port on the mobile device and operating the mobile device within the limited range of a corresponding infrared port at the network access point. Basically, early wireless communication techniques enabled mobile devices to communicate with each other or other computers only within limited physical ranges. The issue of limited range was comprehensively addressed in the nineteen-nineties when computing devices were designed to take advantage of new wireless communication networks. For example, vast cellular telephone systems began to appear in the United States and many other countries around the world.

By the late nineteen-nineties, wireless networks spanned much of the world, allowing mobile computing devices to communicate from almost any location with each other and with remote computers hosting centralized data storage applications. Such remote computers are known as “data servers.” Using these communication networks, salespeople with wireless-modem equipped laptop computers can keep in touch with their companies' centralized inventory and ordering systems. In addition, mobile devices such as personal digital assistants (PDAs) and sophisticated cellular telephones enable users to access the Internet, a worldwide network of computers that collectively stores vast resources of data. Some mobile devices are also able to access a public telephone network (PTN) and/or the Internet to communicate with each other.

With current mobile computing devices, users are able to connect to mail servers, web servers, on-line banking and other server-based or “backend” applications located on remote data servers. Many companies sense the potential advantage afforded by providing access from mobile devices to their systems or servers. Such companies seek to extend their business into the wireless world by offering employees and customers remote access to both user interfaces and backend systems, thus giving users the ability to perform transactions through their mobile devices.

Along with the advantages of portability of mobile computing devices, there are some hurdles to overcome. One of such hurdles is the potential for the wireless network connection between the mobile computing device and the remote server to be lost due to interference or distance. Another is the nature of the wireless connection to be rather slow in transferring large amounts of data back and forth between the remote server and the mobile computing device. In addition, the processes of connecting to and disconnecting from a remote corporate data system can be awkward and confusing.

It is not unusual for a wireless network connection between the mobile computing device and the remote server to be lost simply by moving the mobile computing device from one location to another. Requiring constant connection with the remote server in order to work with applications on the mobile computing device can be problematic. The disruption of a connection during an update of data can corrupt the data. It can also be very slow to work with an application requiring constant connection, due to the often very limited bandwidth available.

Additionally, it can be very costly to remain connected to a wireless network for prolonged periods. Applications that depend on full-time connection to a remote server can be prohibitively expensive.

### SUMMARY OF THE INVENTION

Accordingly, an object of the present invention is to provide a mobile computing device which can conveniently switch connectivity to a communication network.

Another object of the present invention is to provide a method for switching connectivity between a mobile computing device and a communication network.

In order to accomplish the first above-mentioned object, a mobile computing device in accordance with a preferred embodiment of the present invention comprises a data storage and an application. The application is used for performing functions of the mobile computing device, and comprises: a connectivity switching module for receiving demands for connection to or disconnection from a communication network, and for switching connectivity between the mobile computing device and the communication network; a data processing module for processing data in the data storage; a data filter for filtering new or changed data in the data storage; a data synchronizing module for synchronizing data in the data storage with data available on the communication network; and an account setting module for setting various dialup accounts for the mobile computing device to be connected to the communication network.

In order to accomplish the second above-mentioned object, a preferred embodiment of a method of the present invention for switching connectivity between a mobile computing device and a communication network comprises the steps of: (i) receiving a demand for connection to the communication network; (ii) checking whether an active network connection exists between the mobile computing device and the communication network using a default dialup account; (iii) selecting a dialup account if no active network connection exists between the mobile computing device and the communication network using the default dialup account; (iv) connecting the mobile computing device to the communication network; (v) receiving a demand for disconnection from the communication network; and (vi) switching off the connection between the mobile computing device and the communication network.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a block diagram of a typical communication system incorporating a mobile computing device in accordance with a preferred embodiment of the present invention, the mobile computing device being a personal digital assistant (PDA);

FIG. 2 is a block diagram of an alternative communication system incorporating the PDA in accordance with the preferred embodiment of the present invention;

FIG. 3 schematically illustrates an exemplary home screen display on the PDA of the present invention, showing the PDA in a disconnected mode;

FIG. 4 is similar to FIG. 3, but showing the PDA in a connected mode;

FIG. 5 is a schematic diagram of infrastructure of an application server and a database server of the typical communication system of FIG. 1;

FIG. 6 is a schematic diagram of software infrastructure of the PDA of the present invention;

FIG. 7 is a flow chart of connecting the PDA of the present invention to a communication network in accordance with a preferred embodiment of the present invention; and

FIG. 8 is a flow chart of synchronizing data between the PDA of the present invention and the database server of the typical communication system of FIG. 1, in accordance with a preferred embodiment of the present invention.

### DETAILED DESCRIPTION OF PREFERRED EMBODIMENTS OF THE INVENTION

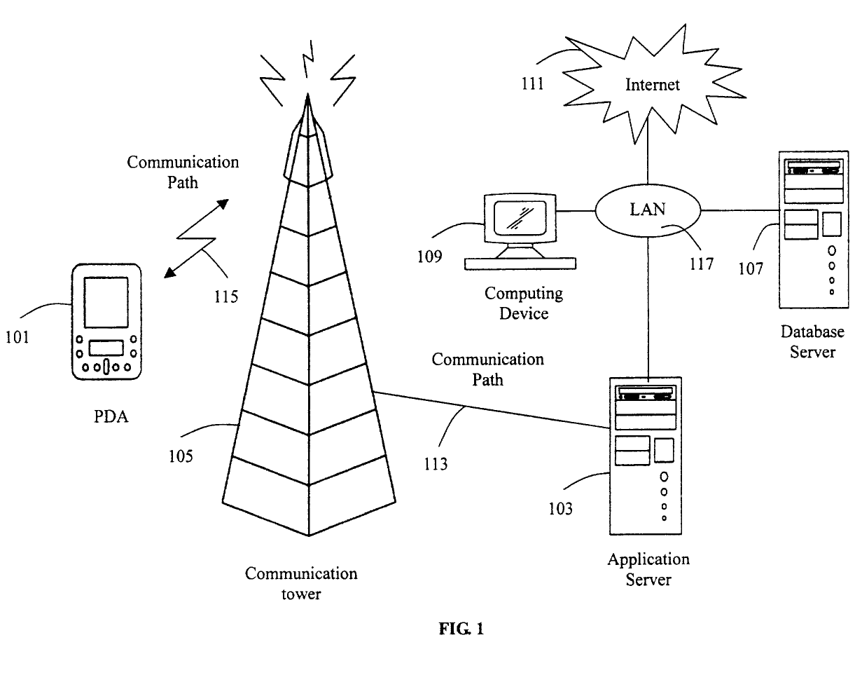

FIG. 1 is a block diagram of a typical communication system incorporating a mobile computing device 101 in accordance with a preferred embodiment of the present invention. The communication system comprises a three-tier information system. The three-tier information system comprises a database server 107 (the bottom tier), a plurality of application servers 103 (the middle tier, only one shown), and a plurality of distributed terminal workstations 101 (the top tier, only one shown). In the preferred embodiment of the present invention, each terminal workstation 101 is one mobile computing device 101, which may be a personal digital assistant (PDA), a laptop computer, or a smart phone. For the sake of convenience, each mobile computing device 101 is deemed to be a PDA 101 for the purposes of describing the preferred embodiment of the present invention. Each application server 103 comprises core and mutable enterprise logic of the communication system. Such logic includes rules for execution and management of the communication system. The application server 103 processes what input by users, and returns results of processing to users. The database server 107 controls processing of data stored in a system database located in the database server 107. Such processing includes reading, writing, deleting, modifying, and backup.

A communication tower 105 provides a communication path 115 to each PDA 101. The PDA 101 wirelessly communicates with the communication tower 105 using a modem (not shown in FIG. 1). The communication tower 105 is also connected to the application servers 103 through a communication path 113. The communication path 113 may be either private or public. In addition, the communication path 113 may or may not be wireless; that is, employ wireless communication. Each application server 103 is coupled to a local area network (LAN) 117, which itself also connects with the database server 107 and a plurality of computing devices 109 (only one shown). The LAN 117 provides access to the Internet 111 for the application servers 103 and the computing devices 109. The PDA 101 therefore also has access to the Internet 111 via the network 117, to any of the application servers 103, to the communication path 113, and to the communication path 115.

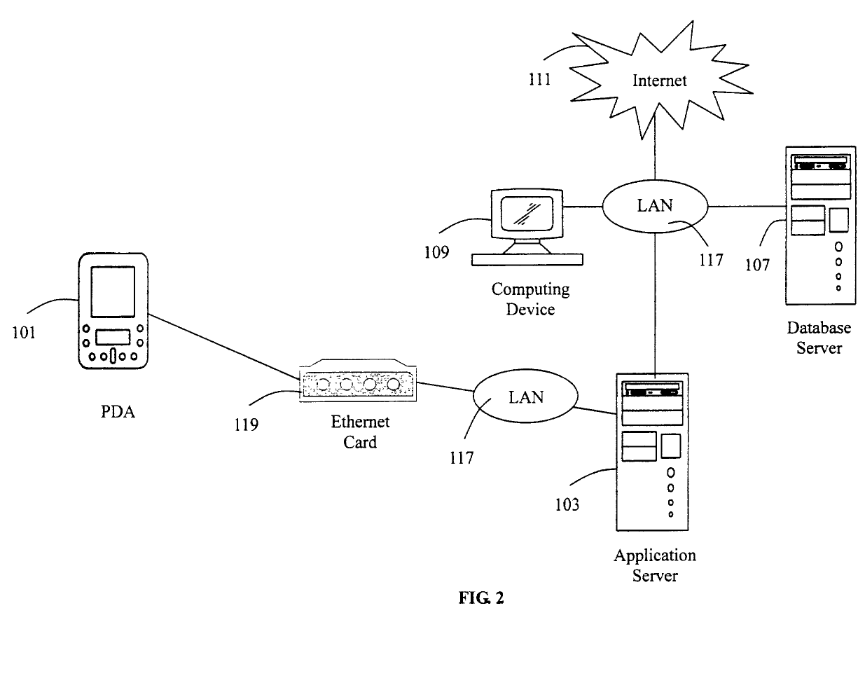

FIG. 2 is a block diagram of an alternative communication system incorporating the mobile computing device 101 in accordance with the preferred embodiment of the present invention. The alternative communication system is similar to the above-described typical communication system. However, in the alternative communication system, the PDA 101 is connected to the LAN 117 using an Ethernet card 119. Through the LAN 117, the PDA 101 can access the application servers 103 and the database server 107.

The above-described typical and alternative communication systems are used as examples only. Many variations of the systems described, and even different types of systems, can also be employed to incorporate the mobile computing device 101 and to practice the claimed method of the present invention (described below). For example, the claimed subject matter can be employed in a LAN-based data server configuration. It should also be apparent to one with skill in the art that the disclosed method can be advantageously deployed within almost any communication or other type of system in which either bandwidth and/or device memory is an issue. Furthermore, the claimed subject matter is not limited to systems that employ wireless communication links. Nevertheless, this is one area in which the advantages of the claimed subject matter are readily apparent.

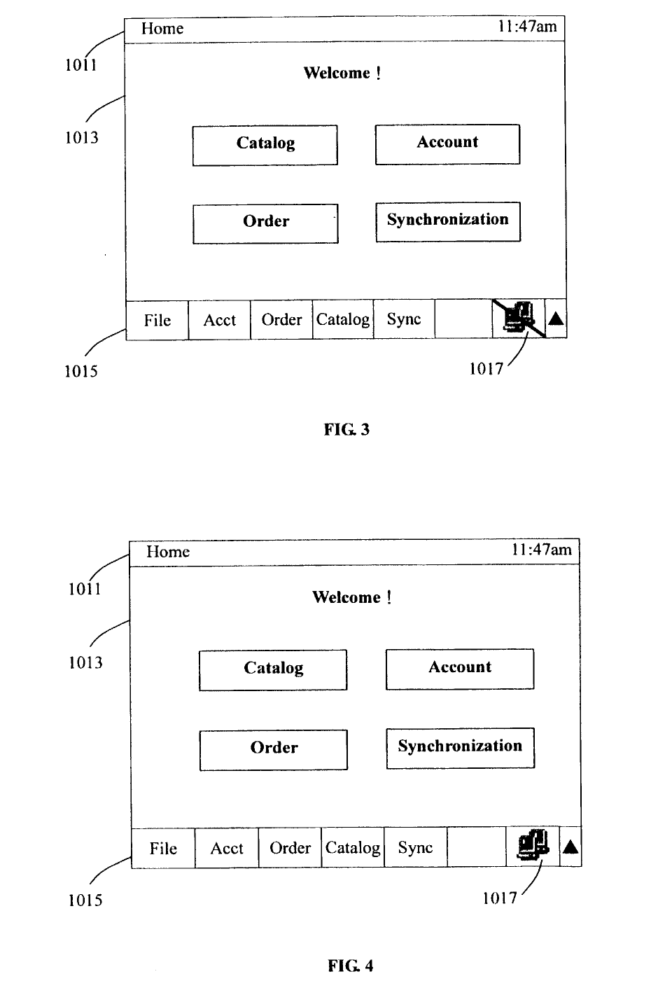

FIG. 3 schematically illustrates an exemplary home screen display on any one of the PDAs 101, showing the PDA 101 in a disconnected mode. Across the top of the screen display is a banner 1011, which includes a title “Home” and the current time “11:47 am.” Below the banner is a message 1013, “Welcome!,” which can be changed to any other appropriate message as desired. Below the message 1013, several screen icons are displayed: a “Catalog” icon, an “Orders” icon, an “Account” icon, and a “Synchronization” icon. Each screen icon represents a particular function. By touching one of the icons with a stylus (not shown), the user executes a corresponding function. Specifically, the Catalog icon executes software on the PDA 101 that enables the user to review, and if desired modify, entries in a Products file. The Orders icon executes software that enables the user to place, and if desired modify, customer orders. The Account icon executes software that enables the user to review, and if desired modify, accounts of the user's customers. The Synchronization icon executes software that enables the user to define, redefine and change options on the user's synchronization filters.

Below the screen icons is a bottom taskbar 1015, which includes options of “Acct,” “Order,” “Catalog” and “Sync” that correspond to the screen icons respectively. By touching one of these options with a stylus, the user can execute through a series of menus (not shown) the same software executed by the corresponding screen icon. In addition to the options corresponding to the screen icons, the taskbar 1015 includes a “File” option. The File option is similar to the file option found in many common programs such as Microsoft Word. That is, the File option displays a menu that enables the user to perform such actions as opening, closing and saving various files that represent the user's work. Most importantly, the taskbar 1015 further includes a connectivity switching icon 1017 which displays a connectivity status between the PDA 101 and an applicable one of the application servers 103 (see FIG. 1). In the preferred embodiment of the present invention, the connectivity switching icon 1017 can represent two modes of connectivity: connected and disconnected. In disconnected mode, the connectivity switching icon 1017 has a red diagonal slash across it (as illustrated in FIG. 3). The PDA 101 cannot access the application server 103, but the PDA 101 still has full functionality. In connected mode, the red diagonal slash is not present (as illustrated in FIG. 4), and the PDA 101 is connected to the database server 107 through the application server 103 for downloading or uploading of data.

FIG. 5 is a schematic diagram of infrastructure of one application server 103 and the database server 107. The database server 107 comprises a database 1070, which is used for storing data such as inventory data of an enterprise. The application server 103 comprises a first data filter 1030, for filtering new or changed data in the database 1070. The application server 103 and the database server 107 are connected with the LAN 117.

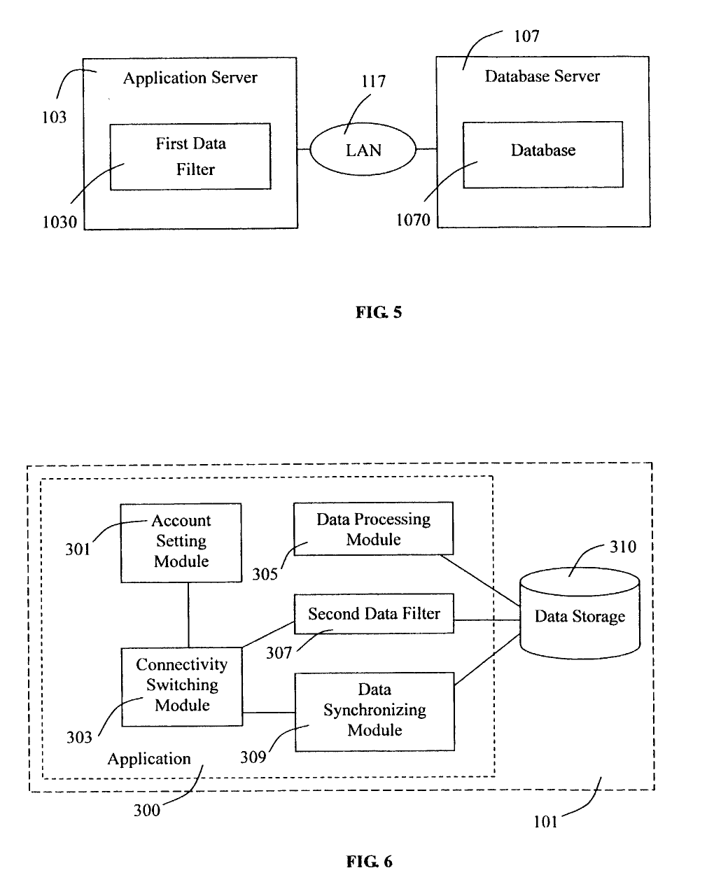

FIG. 6 is a schematic diagram of software infrastructure of any one of the PDAs 101. The PDA 101 includes an application 300 and a data storage 310. The application 300 is used for performing functions of the PDA 101, and comprises an account setting module 301, a connectivity switching module 303, a data processing module 305, a second data filter 307 and a data synchronizing module 309. The account setting module 301 is used for setting various dialup accounts. This is particularly useful when traveling, because it allows different dialup connections to be used in regions having different telephone area codes, thereby avoiding expensive long distance phone charges. The connectivity switching module 303 is used for receiving demands for connection or disconnection sent by a user, and for switching connectivity between the PDA 101 and the application server 103 or the LAN 117. The data processing module 305 provides processing of data in the data storage 310. The second data filter 307 is used for filtering new or changed data in the data storage 310 in disconnected mode. If the PDA 101 does not contain data in the data storage 310, and the second data filter 307 is executed in connected mode, then data is simply downloaded from the database 1070 in the database server 107. The data synchronizing module 309 is used for synchronizing data between the PDA 101 and the database server 107 in connected mode.

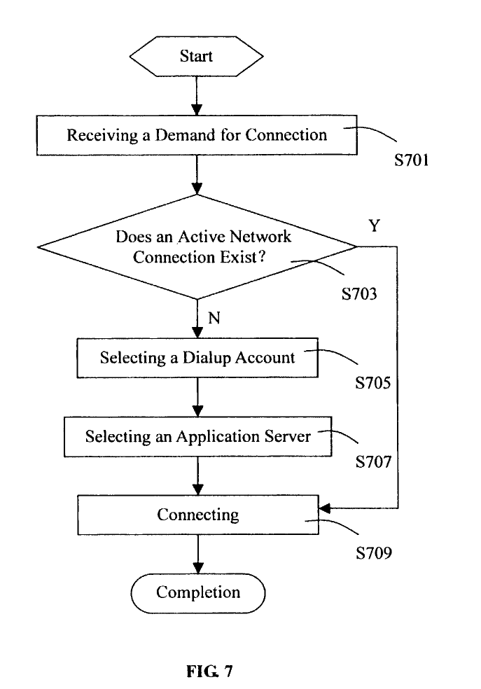

FIG. 7 is a flow chart of connecting one PDA 101 to a communication network in accordance with a preferred embodiment of the present invention. When the PDA 101 is started up, it shows a home screen display as illustrated in FIG. 3. A red diagonal slash is displayed across the connectivity switching icon 1017. If a user wants to connect the PDA 101 to a communication network, he/she can touch the connectivity switching icon 1017. At step S701, the connectivity switching module 303 receives the demand for connection. At step S703, the connectivity switching module 303 checks whether an active network connection exists. This is accomplished using a default dialup account. A ping is sent to a host name of one application server 103 on the communication network. Ping is a protocol that sends a message to another computer and waits for acknowledgment, and is commonly used to check if another computer on a network is reachable. If the ping succeeds, at step S709, the PDA 101 is changed into connected mode. If the ping fails, it is assumed that there is no active network connection, and a drop-down dialup connection box appears (not shown). At step S705, the user can select a dialup account from the dialup connection box for connection. If an enterprise employs a distributed information system, then when traveling from one place to another, at step S707, the user can select a closest application server 103 to connect with. This improves t he capability of data transmission, and is done using a URL. The URL contains an Internet address of an application server 103, along with a servlet name if a Java implementation is used. In an alternative embodiment of the present invention, the user cannot select an application server 103 to connect with. At step S709, the PDA 101 is changed into connected mode. Then the user can download data from and/or upload data to the database server 107 through the application server 103. After operations in connected mode are finished, the user touches the connectivity switching icon 1017 to switch off the connection between the PDA 101 and the communication network including the application server 103.

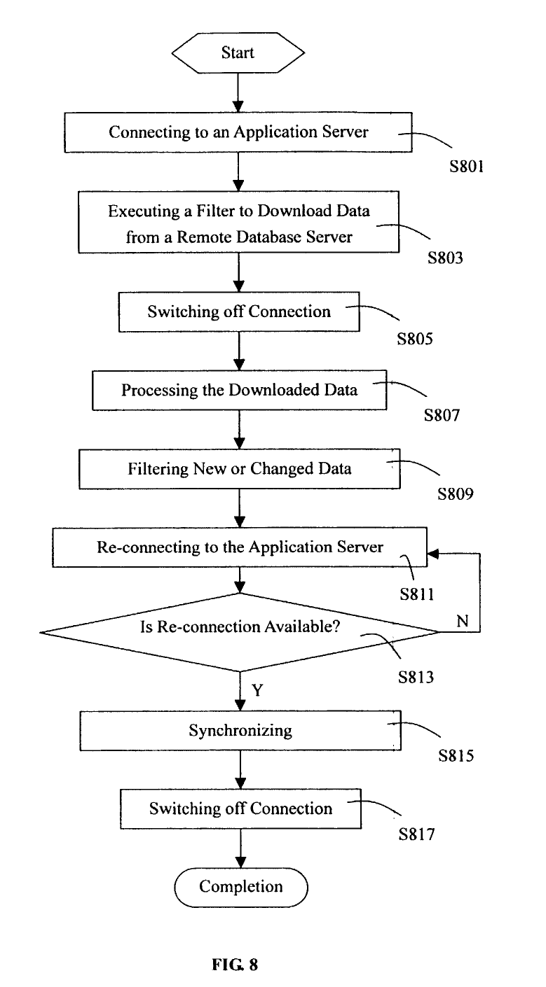

FIG. 8 is a flow chart of synchronizing data between the PDA 101 and the database server 107. In the preferred embodiment of the present invention, the PDA 101 is used by a salesperson, and an application server 103 and a database server 107 of an enterprise are employed. It is assumed that the PDA 101 is used for the first time. When the salesperson touches the connectivity switching icon 1017 on the PDA 101 to send a demand for connection, at step S801, the connectivity switching module 303 connects the PDA 101 to the application server 103. At step S803, the second data filter 307 is executed to download required data to the data storage 310 from the database 1070 in the database server 107 through the application server 103. For example, inventory data on an article such as article name, quantity, sales price and purchase price can be downloaded. After finishing downloading of the required data, at step S805, the salesperson touches the connectivity switching icon 1017 to switch off the connection with the application server 103. At step S807, the salesperson processes the downloaded data. For example, after selling one piece of the article, the salesperson updates the quantity of the article, and adds a sale record in the data storage 310. At predetermined time intervals, such as every 24 hours, the salesperson synchronizes data in the data storage 310 with data in the database 1070. At step S809, the second data filter 307 filters new or changed data in the data storage 310, such as the change in the quantity of the article and the added sale record. Meanwhile, the first data filter 1030 filters new or changed data in the database 1070. When the salesperson touches the connectivity switching icon 1017 to send a demand for re-connection, at step S811, the connectivity switching module 303 re-connects the PDA 101 to the application server 103. At step S813, the connectivity switching module 303 sends an impulse (such as an http request) to the application server 103 automatically. That is, the connectivity switching module 303 pings to a host name of the application server 103, to confirm whether the re-connection is available. If the re-connection is available, the PDA 101 is back in connected mode. If the re-connection is unavailable, the synchronizing procedure goes back to step S811 for re-connection. At step S815, the data synchronizing module 309 uploads new or changed data in the data storage 310 to the database 1070, and/or downloads new or changed data from the database 1070 to the data storage 310. During this synchronizing procedure, only new or changed data are transferred, and the new or changed data generally represent only a very small proportion of data in the data storage 310 or in the database 1070. As a result, performance of the PDA 101 is greatly enhanced, and the salesperson saves a lot of time. Additionally, connection fees are minimized, no matter whether such fees are time-based online fees or fees based on the amount of data transferred. After finishing the synchronizing procedure, at step S817, the salesperson touches the connectivity switching icon 1017 to switch off the connection with the application server 103.

While the present invention has been described above, it should be understood that it has been presented by way of example only and not by way of limitation. Thus the breadth and scope of the present invention should not be limited by the above-described exemplary embodiments, but should be defined only in accordance with the following claims and their equivalents.

What is claimed is:

1. A mobile computing device, comprising:
a data storage; and
an application for performing functions of the mobile computing device, the application comprising:
a connectivity switching module for receiving demands for connection to or disconnection from a communication network, and for switching connectivity between the mobile computing device and the communication network;
a data processing module for processing data in the data storage;
a data filter for filtering new or changed data in the data storage; and
a data synchronizing module for synchronizing data in the data storage with data available on the communication network.

2. The mobile computing device as claimed in claim 1, wherein the mobile computing device is a personal digital assistant.

3. The mobile computing device as claimed in claim 1, wherein the mobile computing device is wirelessly connected to a communication network by means of a modem.

4. The mobile computing device as claimed in claim 1, wherein the mobile computing device is connected to a communication network by means of an Ethernet card.

5. The mobile computing device as claimed in claim 1, wherein the application further comprises an account setting module for setting various dialup accounts for the mobile computing device to be connected to the communication network.

6. A method for switching connectivity between a mobile computing device and a communication network, the method comprising the steps of:
(a) receiving a demand for connection to the communication network;
(b) checking whether an active network connection exists between the mobile computing device and the communication network using a default dialup account;
(c) selecting a dialup account if no active network connection exists between the mobile computing device and the communication network using the default dialup account; and
(d) connecting the mobile computing device to the communication network.

7. The method as claimed in claim 6, wherein the mobile computing device is a personal digital assistant.

8. The method as claimed in claim 6, further comprising the steps of:
receiving a demand for disconnection from the communication network; and
switching off the connection between the mobile computing device and the communication network.

9. The method as claimed in claim 6, wherein step (b) is accomplished via a ping to a server on the communication network.

10. The method as claimed in claim 6, wherein step (d) further comprises the step of:
selecting a server on the communication network to connect with.

11. A method for data transmission between a mobile computing device and a communication network, wherein said mobile computing device is programmed with a default dialup account while accompanying a prompt before connection choice; the method comprising the steps of:
(a) receiving a demand for connection to the communication network;
(b) checking whether the default dialup account is available and/or economic in comparison with other dialup accounts stored in a database;
(c) selectively connecting to a proper dialup account maybe other than said default account; and
(d) activating synchronization once corresponding connection succeeds; and
(e) disconnecting the mobile computing device from the communication network once the synchronization is finished, while still keeping said mobile computing device connected to an internet via which the mobile computing device and the communication network are connected for data transmission.
